(19) United States
(12) Patent Application Publication
(10) Pub. No.: US 2015/0075044 A1
(43) Pub. Date: Mar. 19, 2015

(54) CUSTOM FRAMED LED LIGHT PANEL DISPLAY

(71) Applicant: Barton Nelson, Inc., Kansas City, MO (US)

(72) Inventors: Gunnard Nelson, Stilwell, KS (US); Ian Nelson, Stilwell, KS (US)

(73) Assignee: Barton Nelson, Inc., Kansas City, MO (US)

(21) Appl. No.: 14/028,304

(22) Filed: Sep. 16, 2013

(51) Int. Cl. G09F 13/04

(52) U.S. Cl. CPC G09F 13/0413
USPC 40/489; 362/97.4

(57) ABSTRACT

Custom LED light panel displays (20, 20a, 20b) are provided, equipped with transparent media covers (22), replaceable, image-bearing media sheets (24), and support and illumination assemblies (26) having backing panels (38) supporting the sheets (24). The sheets (24) are located between the covers (22) and the backing panels (38), and can be readily replaced without disassembly of the displays (20, 20a, 20b). The displays (20, 20a, 20b) are illuminated by means of peripheral LED lights (86) disposed about central panel sections (50) forming a part of the backing panels (38). The LED-emitted light may be4 scattered or changed in color to achieve different illumination patterns.

### BACKGROUND OF THE INVENTION

1. Field of the Invention

The present invention is broadly concerned with aesthetically pleasing light-emitting diode (LED) illuminated displays, which can be used to good effect for advertisement and promotional purposes. More particularly, the invention is concerned with such displays, and methods of display illumination, wherein displayed images may be readily and rapidly changed, with a variety of different lighting motifs, both in terms of the intensity of illumination, and the color and placement of the illumination.

2. Description of the Prior Art

Sellers of consumer products constantly seek new ways to display images of their wares which are eye-catching and aesthetically pleasing. For example, it has been known in the past to provide illuminated panel displays using LED strip lights. While these units have had significant success, they are deficient in many important respects. For example, with these prior units, it is very difficult to change the displayed images therein, often requiring complete disassembly of the units. Moreover, these prior displays generally have only a single type and color of generalized illumination, and cannot provide illumination patterns of varying colors and intensities.

These limitations significantly decrease the desirability of standard LED displays. For example, sellers of cellular telephones often desire to display the latest telephone designs for a short period of time while the new design is in vogue, and thereafter would like to display another, perhaps newer telephone design. Similarly, automobile dealerships often want to display images of a given model for a period of time, followed by display of a different model. With conventional displays, it is necessary either to completely disassemble the display, or to replace it altogether, when a new sales campaign is launched with a different telephone or automobile model. As a practical matter, therefore, the prior displays lack the ability to be easily modified in terms of the images displayed, or the illumination pattern associated with given images.

### SUMMARY OF THE INVENTION

The present invention overcomes the problems outlined above and provides greatly improved LED displays, which can be altered in a matter of seconds without the necessity of disassembly, both in terms of the image displayed and the illumination thereof.

In one aspect of the invention, a display comprises a backing panel presenting opposed front and rear faces and a thickness between the opposed faces, with the backing panel having a central panel section oriented to receive a replaceable sheet of light-transmitting media bearing an image, so that the media sheet is located proximal to the front face of the central panel section. The overall display further includes a light-transmitting cover located over the central panel section and media, as well as an illumination assembly operable illuminate the media and image in order to permit viewing of the image through the cover. The display also has structure supporting the cover in covering relationship over the media, including a quick-release device permitting rapid manual shifting of the cover to expose the media and to permit replacement thereof with new media bearing another image. The quick-release structure can take a variety of forms, magnetic components, Velcro® components, quarter-turn connector components, snap components, hinge/latch components, and combinations thereof.

In preferred forms, the backing panel is formed of substantially white and opaque synthetic resin material, and one face of the backing panel is laser-etched to facilitate even “white light” illumination thereof, and especially the central panel section. The LED lights are usually located adjacent the backing panel and oriented to transmit light through the thickness thereof in order to illuminate the central panel section and the media.

In many cases, light-scattering structure is provided in order to alter the illumination pattern of the emitted LED light. Such light-scattering structure may be integral with the components of the display, or separable therefrom. The light scattering structure is typically placed proximal to the LED lights for scattering of the emitted light before passage through the other light-transmitting display components. As used herein, light “scattering” refers to any phenomena occurring when light impinges upon a non-smooth surface, including but not limited to the disruption, distortion, reflection (both specular and diffuse), diffusion, deflection, and refraction. In certain embodiments, the light-scattering structure may be prism-like (i.e., a medium that distorts, slants, or colors incident light), and present a pair of converging faces. Light-scattering structures may be used to generate even illumination of the backing panel, or to create illumination having different intensities at different locations on the display.

Use can also be made of replaceable coloration elements located in the path of the emitted LED light, either directly from the LEDs or reflected LED light. These elements may be formed of colored material or be formed of clear material having colored outer surfaces. A given coloration element may also have different colors along the length thereof. In this fashion, the illumination pattern may have different colors at different display locations.

The invention also provides novel methods of illuminating a display including a backing panel for an image and having front and rear faces and a thickness between the faces. These methods comprise the steps of directing light emitted by a plurality of LED lights first through a replaceable coloration element in order to change the color of the light, and thereafter directing the light through at least a portion of the backing panel. Such emitted light may be scattered prior to or after passage of the light through the coloration element. In this manner, varying color displays can be easily provided. If differential illumination is desired, greater amounts of the LED-emitted light may be directed or focused toward one portion of the backing panel, while other portions thereof receive less or no illumination.

### BRIEF DESCRIPTION OF THE DRAWINGS

FIG. 1 is a perspective view of a display in accordance with the invention;

FIG. 2 is a partial exploded perspective view of the display of FIG. 1, illustrating certain components thereof;

FIG. 3 is a complete exploded perspective view of the display of FIG. 1, illustrating all of the components thereof;

FIG. 4 is an elevational view of the backing panel forming a part of the display, illustrated with side marginal LED lights and the rear panel of the display secured to the backing panel;

FIG. 5 is an enlarged, fragmentary view of the upper left corner of the display illustrated in FIG. 1, depicting the respective display components and their relationship to each other;

FIG. 6 is a rear perspective view of the FIG. 1 display, illustrating the preferred wall stand-off mounting structure;

FIG. 7 is a perspective view of the rear face of the media cover forming a part of the display of FIG. 1, and illustrating the corner-magnets forming a part of the quick-connect structure of the display;

FIG. 8 is a perspective fragmentary sectional view of a side margin of the FIG. 1 display;

FIG. 9 is a perspective view with parts broken away of a side margin of the FIG. 1 display, illustrating the LED lights, the inboard and outboard light-scattering structures, and a color bar, all forming a part of the display;

FIG. 10 is a perspective view similar to that of FIG. 9, but illustrating another embodiment not having the outboard light-scattering structures;

FIG. 10A is a greatly enlarged fragmentary view illustrating one preferred design of the light-scattering structures of the displays of FIGS. 1-10;

FIG. 11 is a fragmentary front view illustrating another display design having a differently configured middle backing panel having an inboard horizontal edge presenting differently configured prism-like elements along the length thereof;

FIG. 12 is an elevational view of another display design having a middle backing panel with different outwardly extending decorations, as compared with the embodiment of FIGS. 1-11;

FIG. 13 is a color photograph of the FIG. 12 display, where no coloration bars are employed;

FIG. 14 is a color photograph of a side perspective view of the FIG. 13 display;

FIG. 15 is a color photograph of a side perspective view of the FIG. 13 display, illustrating a user opening the media cover to allow access to the replaceable media sheet and the horizontal and vertical slots designed to receive coloration bars;

FIG. 16 is a color photograph similar to that of FIG. 15, but depicting insertion of multi-colored coloration elements in the horizontal and vertical slots;

FIG. 17 is a color photograph similar to that of FIG. 16, showing the multi-colored coloration elements situated within the slots and prior to closure of the media cover;

FIG. 18 is a color photograph of the display of FIG. 17, depicting the differential coloring afforded by the use of the multi-colored coloration elements;

FIG. 19 is a color photograph of a side perspective view of the FIG. 18 display, illustrating the differential color effect along the side margin of the display;

FIG. 20 is a color photograph similar to that of FIG. 16, but depicting the insertion of amber-colored coloration elements into the display slots, in lieu of the multi-colored coloration elements;

FIG. 21 is a color photograph similar to that of FIG. 17, illustrating closure of the media cover with the installed amber-colored coloration elements;

FIG. 22 is a color photograph similar to that of FIGS. 13 and 18, and illustrating the display with the amber-colored coloration elements; and

FIG. 23 is a color photograph of a side perspective view of the display of FIG. 22 illustrating the amber color effect along the side margin of the display.

### DETAILED DESCRIPTION OF THE PREFERRED EMBODIMENTS

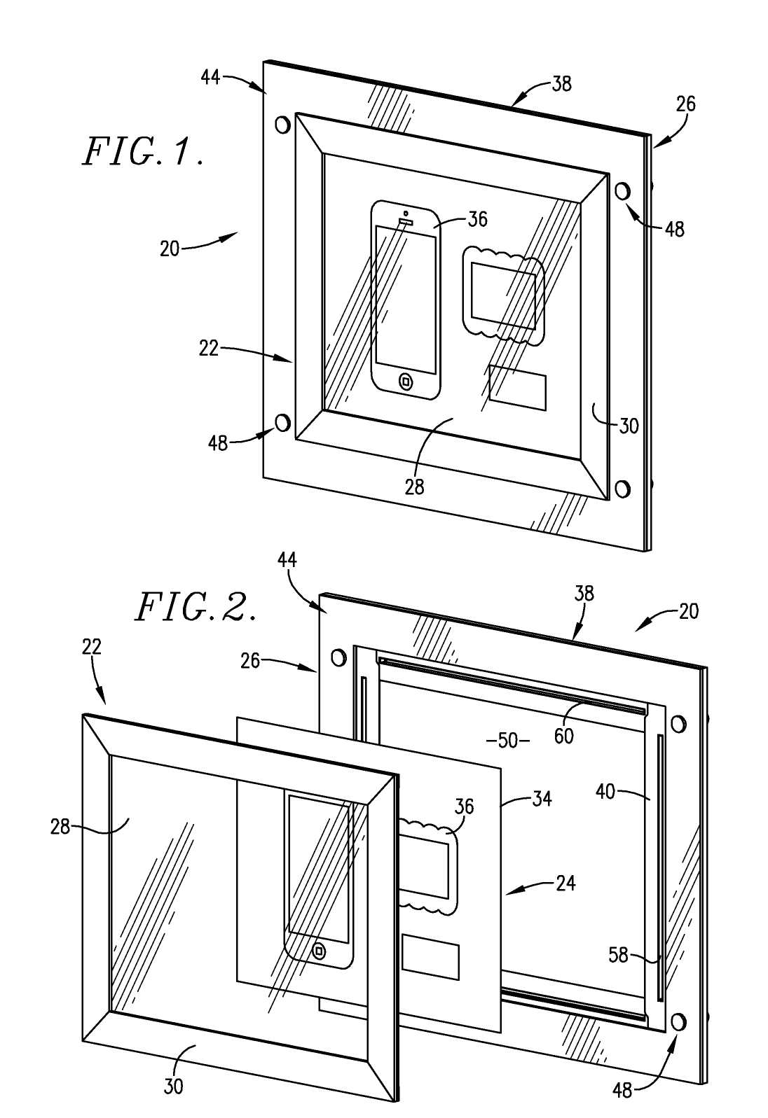

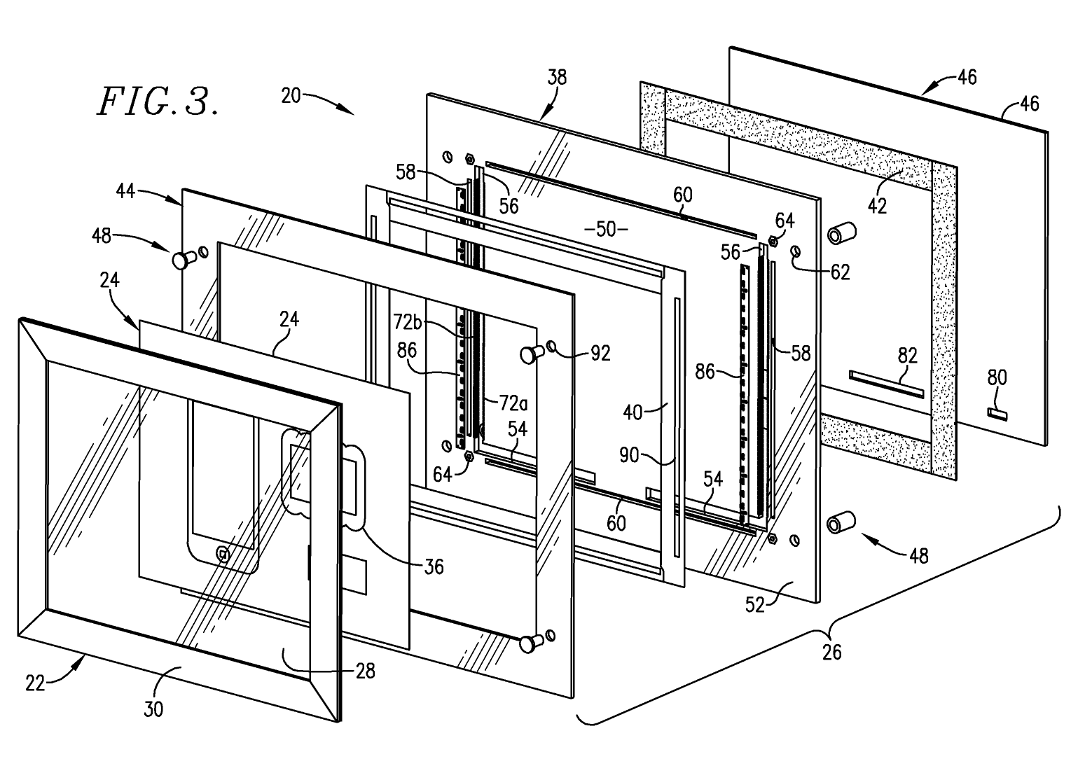

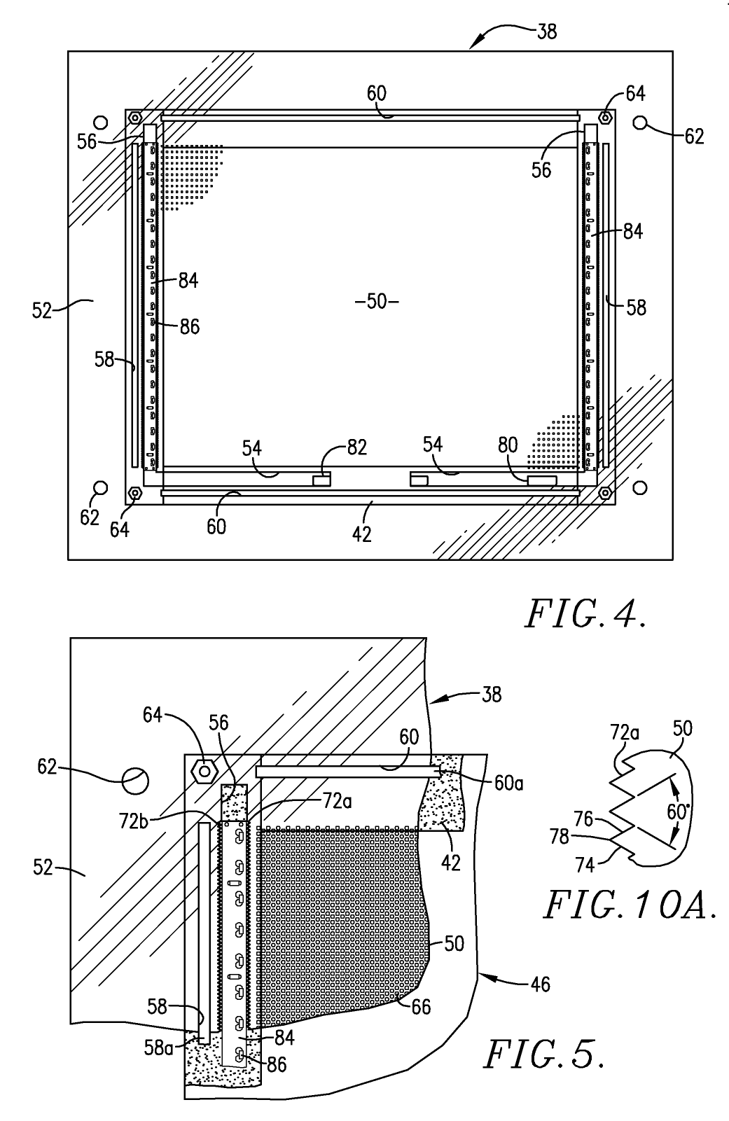

Embodiment of FIGS. 1-9

Turning now to the drawings, a display 20 is illustrated in FIGS. 1-3 and broadly includes a media cover 22, a replaceable, image-bearing media sheet 24, and a support and illumination assembly 26. The display 20 may be wall- or easel-mounted as desired, and is typically used in advertising promotions, i.e., the media sheet 24 has an image such as a photograph and/or text, which is illuminated and displayed in an aesthetically pleasing manner. Moreover, the design of the display 20 makes it very easy to replace a given media sheet 24 with a new replacement media sheet.

The media cover 22 includes a sheet 28 of substantially transparent glass or synthetic resin material, with a surrounding frame 30. In the specific illustrated embodiment, the rear face of the frame 30 is equipped with corner-mounted magnets 32 (FIG. 7); the purpose of these magnets will be made clear hereinafter.

The media sheet 24 is formed of a thin, light-transmitting sheet 34 of synthetic resin, e.g., acetate, which has been imprinted with or otherwise bears an image 36, in this example a photograph of a cellular telephone and related advertising information. Of course, any desired image may be displayed on the media sheet 24.

The support and illumination assembly 26 broadly includes a middle backing panel 38, front and rear tapes 40 and 42, and front and rear panels 44 and 46. The components of the assembly 26 are secured together in a face-to-face manner with appropriate couplers, in this instance the standoff screw assemblies 48.

The backing panel 38 is preferably formed of white opaque acrylic material having a thickness of from about 1/16-¼ inch (more preferably about ⅛ inch) and presents a substantially rectangular central panel section 50 and an interconnected peripheral surrounding margin 52. The panel additionally has a pair of lower, rectangular wireway slots 54, and a pair of vertically extending slots 56 adjacent the side margins of central panel section 50, such that the slots 56 are located between the central panel section 50 and margin 52. The margin 52 has four slots, namely side marginal vertical slots 58 outboard of the slots 56, and transverse slots 60 respectively located above and below the central panel section 50. The margin 52 further includes four corner mounting holes 62, and four metallic inserts 64, as shown.

The rear face of central panel section 50 is laser-etched to present a series of ablated circular zones 66. These zones cover the entirety of the rear face, and are etched so that the zones in the central region of the rear face are slightly larger than the zones at the periphery of the rear face. In other words, the zone areas are the smallest at the edges of the rear face, and gradually increase in an even gradient towards the largest zone areas at the center. The purpose of the ablated zones 66 is to facilitate full and even illumination of the central panel section 50, as will be described below.

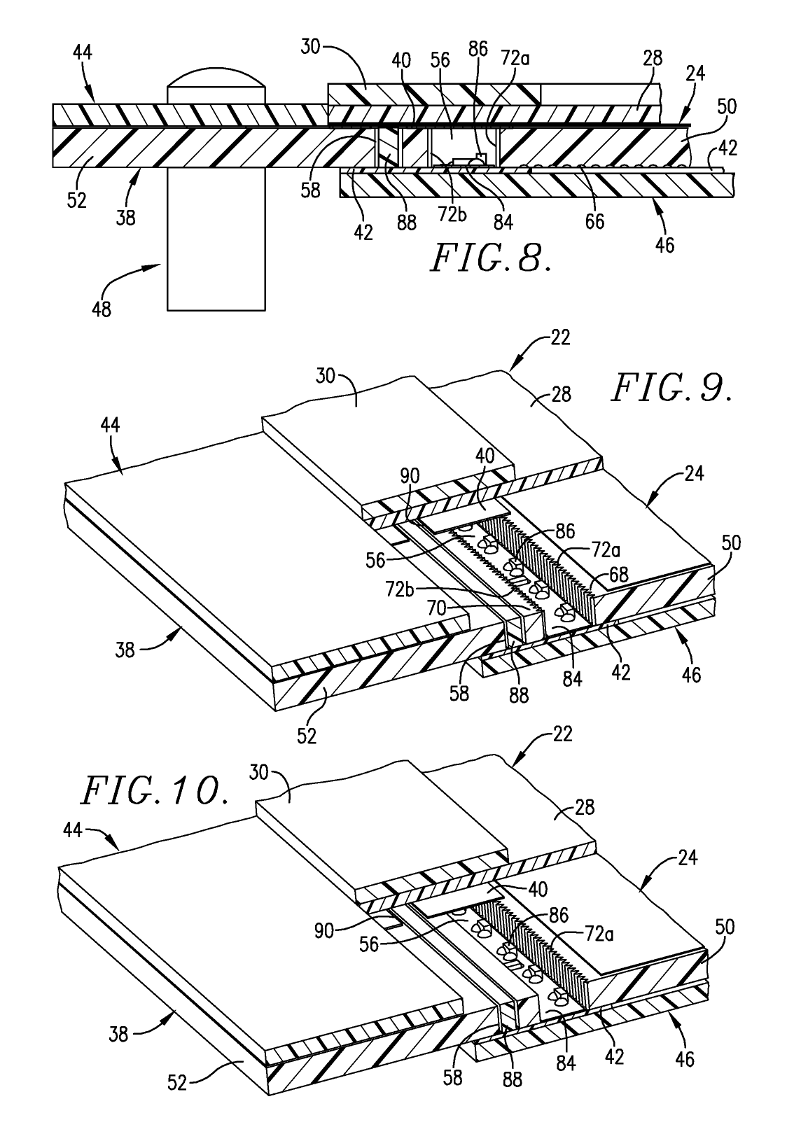

Referring to FIGS. 8-9, it will also be seen that the slots 56 are defined between the outermost vertical edge 68 of central panel section 50, and the innermost vertical edge 70 of margin 52. As shown, each of the edges 68 and 70 is formed to present a series of upright, abutting, regular prism-like elements 72a and 72b along the entire lengths thereof. These elements 72a, 72b are identical (FIG. 10A) and each present a pair of converging faces 74, 76, which terminate at an apex 78. The included angle between the faces 74, 76 in the depicted embodiment is 60°, and the faces have a length of about 0.05 inches in the planes thereof. It should be understood, however, that these dimensions and geometries may change, depending upon the lighting effect desired in the display 20. As used herein, “prism-like” elements or structures refers to any non-smooth surface(s) or configuration(s) which serve to scatter (as defined above) incident light.

The rear tape 42 is rectangular in shape and is in the form of double-faced polyurethane foam tape, which is adhered to the rear face of backing panel 38 and the front face of rear panel 46, so that the backing panel and rear panel are unitized. It will be observed that the tape 42 covers the open backs of the slots 56, 58, and 60. As illustrated, the rear panel 46 has an opening 80 for an electrical connector, and a wireway opening 82 which communicates with the wireway slots 54.

A pair of elongated LED light strips 84 are respectively located in the vertical slots 56 and extend along the length thereof. The strips 84 are maintained in place by virtue of the adhesive on the tape 42. The strips 84 include a plurality of spaced apart LED lights 86, which are designed to direct emitted light through the prism-like elements 72a and the thickness of central panel section 50 so as to illuminate the latter. The elements 72a, together with the described laser-etching on the rear face of central panel section 50, serves to even out this LED-emitted light to create a substantially even illumination throughout the area of the section 50. Such LED light strips are well known, and may be obtained from EnvironmentalLights.com. The depicted light strips are Daylight White 3014 side view LED Strips having a color temperature of 6,500° K, and are spaced 0.14 inches (10.4 mm) apart, product no. dirfEV3014-96-reel, obtained from the above source.

The slots 58 and 60 may be equipped with elongated replaceable coloration bars or elements 88, in the form of rod-like members, preferably rectangular in cross-section, and formed of light-transmitting material. The elements 88 may be formed of a colored synthetic resin material (e.g., red or blue), or may be clear with an application of external tape or the like having the desired color. In the illustrated embodiment, only two elements 88 are employed, located within the vertical slots 56. In other instances, all four of the slots 58, 60, may be equipped with elements 88, or only the transverse slots 60.

The front tape 40 covers the forward ends of the slots 56, as best seen in FIGS. 8-9, and has four marginal slots 90, which register with the vertical and transverse slots 58, 60 designed to receive coloration bars. The front panel 44 is formed of any suitable synthetic resin material, and has four corner apertures 92 to receive the assemblies 48.

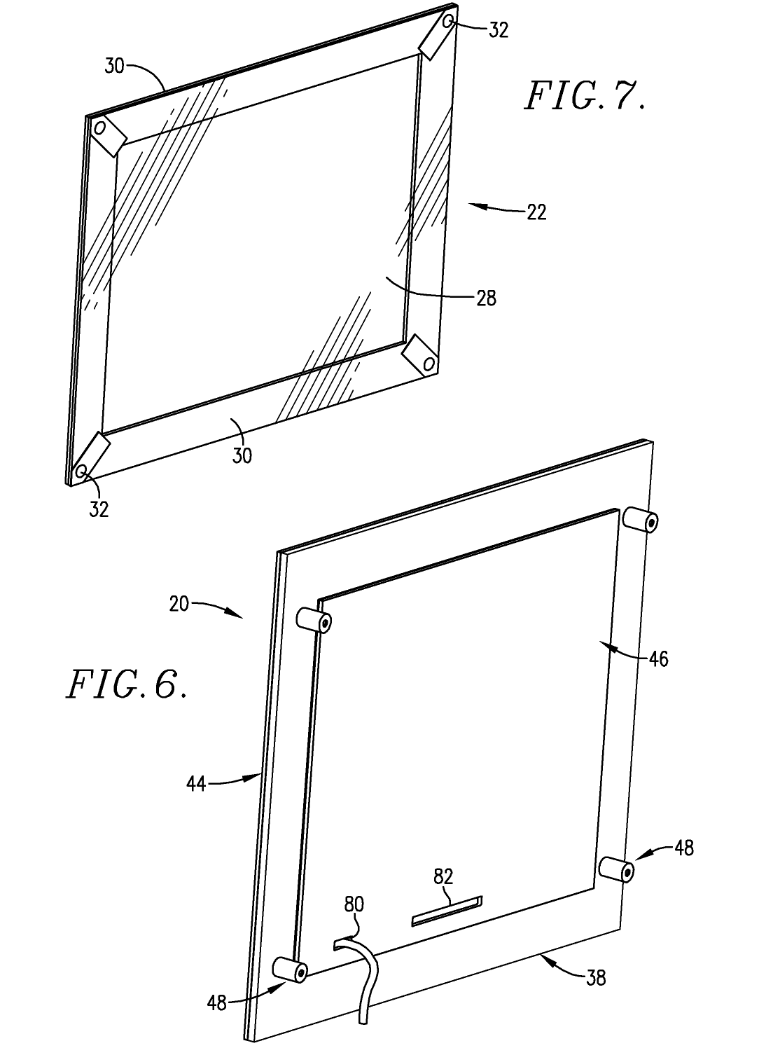

The support and illumination assembly 26 is constructed by first adhering the rear face of tape 42 to the front face of rear panel 46, followed by adhering the front face of the tape 42 to the rear face of backing panel 38. Thereupon, the desired LED strips 84 are located within the upright slots 56 and are adhered to the tape 42, and paper covers 58a and 60a (FIG. 5) are applied to the bottom surfaces of the open slots 58, 60 in order to cover the adhesive along the length of the slots. The desired coloration elements 88 are then positioned within the slots 58 and/or 60. The electrical leads of the strips 84 are then threaded through the display and are coupled with a power cord (see FIG. 6).

Next, the front tape 40 is applied to the front face of backing panel 38 to cover the installed strips 84, while permitting access to the color bars 88 through the slots 90. Appropriate wiring for the stripe 84 is then installed through the wireways 54 and slots 80, 82, and rear panel 46 is adhered to the rear tape 42. Finally, the front panel 44 is installed with the standoff screw assemblies 48, to thereby sandwich the components of the assembly 26 together and to provide a convenient method of mounting the entire display 20 to a vertical wall.

Once the assembly 26 is constructed, it is a simple matter to apply the media sheet 24 over the central panel section 50 of backing panel 38, and to install the media cover 22. The latter is accomplished by simply placing the rear magnets 32 thereof in opposition to the metallic inserts 64 of backing panel 38 so as to magnetically adhere the media cover in place. It will be appreciated that any particular media sheet 24 can be readily removed and replaced, by merely detaching the media cover 22, removing the previously displayed sheet 24, and inserting new sheet in place thereof. The media cover 22 can then be reinstalled, as described. In addition, if a new design color is desired, the coloration elements 88 can also be replaced or supplemented.

Operation

When a desired media sheet 24 is placed within the display 20 as described, the LED lights 86 of the strips 84 are illuminated by an appropriate electrical power-on. This serves to generate visible light which is directed inwardly from the lights 86 through the inboard light-scattering structures 72a and thence through the thickness of the central panel section 50. This illumination, together with the effect of the laser-etching on the rear face of central panel section 50, serves to create an essentially uniform “white light” which illuminates the entirety of the section 50. Inasmuch as the media sheet 24 is formed of light-transmitting material, this illumination serves to dramatically highlight the image 36.

Additionally, a portion of the light emitted from the lights 86 is reflected from the structures 72a and serves to illuminate the peripheral margin 52. That is, the reflected light first passes through the outboard structures 72b and then through the thickness of the margin. In the event that coloration elements 88 are situated within the slots 58, the margin may be illuminated in the corresponding color(s), to further accentuate the image 36 on media sheet 24. The provision of inboard and outboard structures 72a and 72b creates substantially even illumination both of the central section 50 and margin 52, albeit in different colors as dictated by the colors of the elements 88.

Embodiment of FIGS. 10 and 10A

The embodiment of FIG. 10 is exactly the same of that of FIGS. 1-9, save for the fact that the outboard structures 72b are eliminated, and thus the inner surface of the margin 52 is smooth and does not serve to scatter light, as described. Consequently, the illumination of margin 52 is not entirely even, which may be desirable in particular contexts of advertising or promotion.

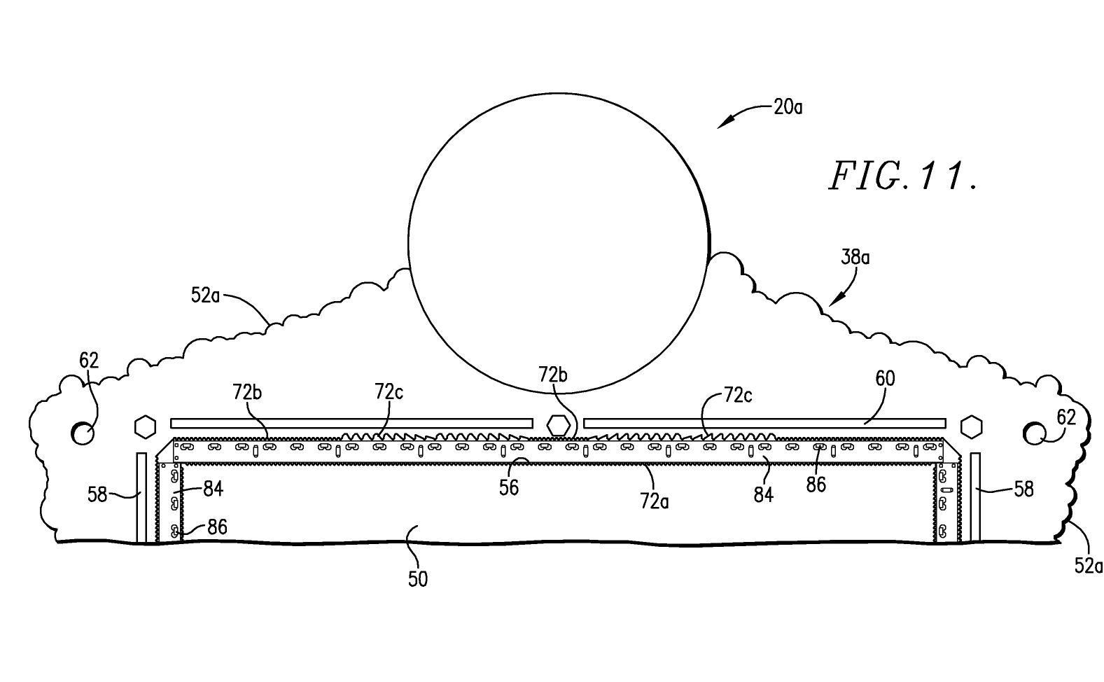

Embodiment of FIG. 11

FIG. 11 illustrates another display 20a in accordance with the invention having the same components as previously described, save for a differently configured middle backing panel 38a having a decorative, stylized outer margin 52a, which can itself have differently colored elements. This embodiment further differs from that of FIGS. 1-9 in the provision of prism-like elements along the outer edge of the upper, horizontally extending slot 56. Specifically, the prism-like elements include endmost sections and a central section 72b, which are configured in the manner of the elements 72a, but with intermediate sections 72c, which have differently designed shapes and orientations. This allows a different illumination pattern through the margin 52a, at the discretion of the user. By providing the elements 72c, light can be cast in different directions and intensities, dependent upon the geometry of the elements 72c.

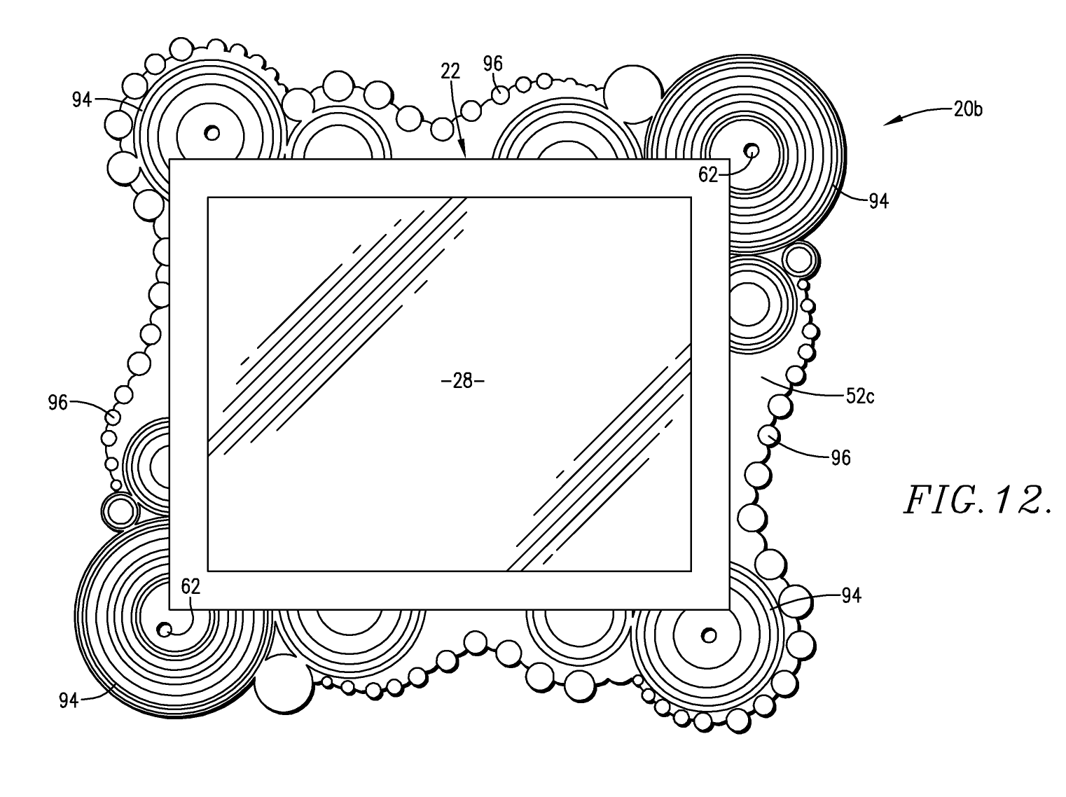

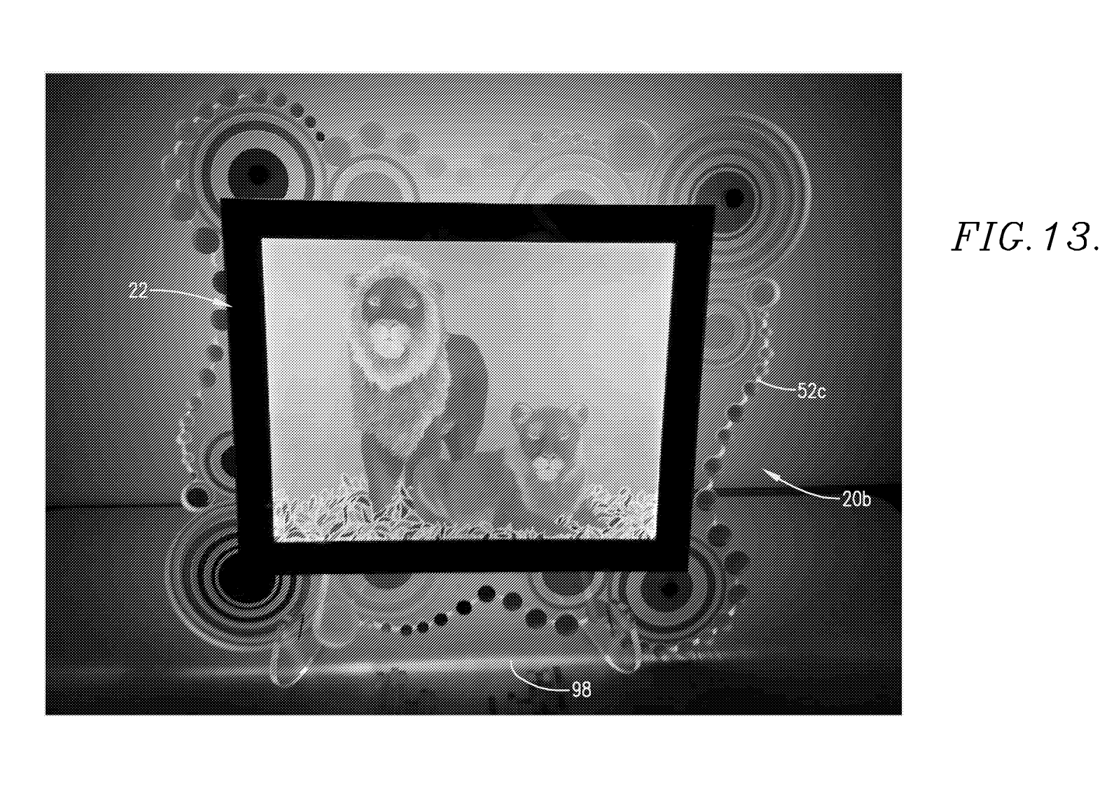

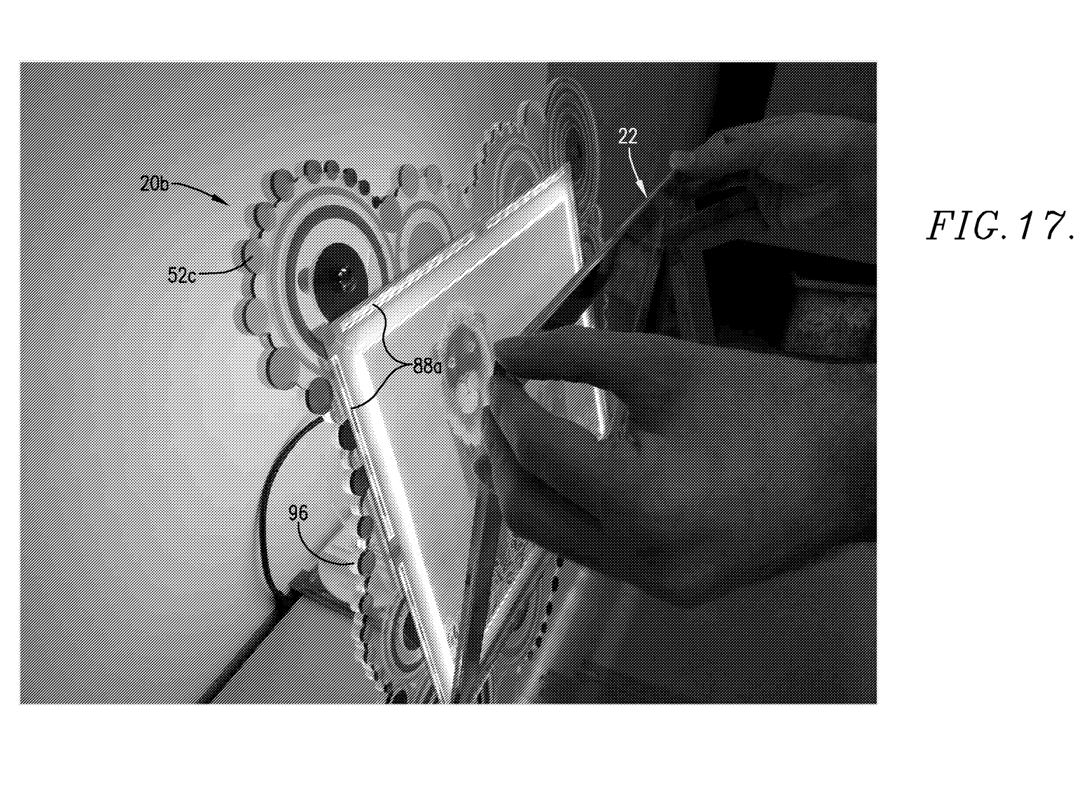

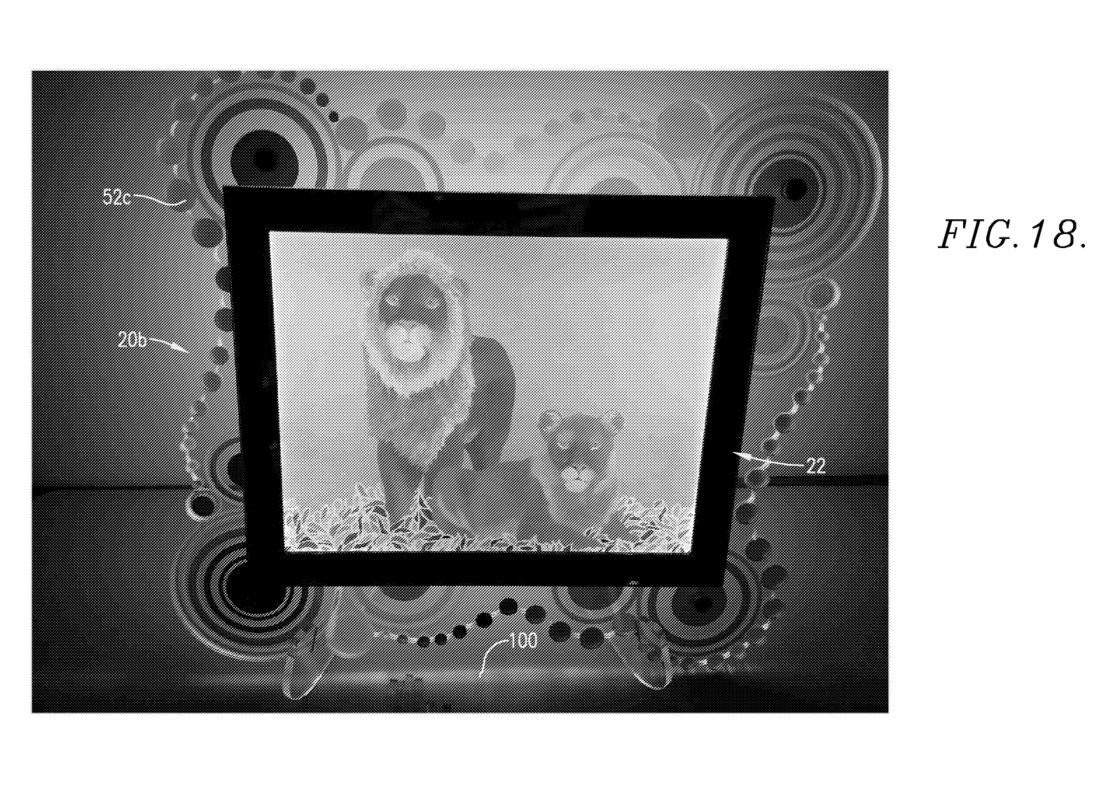

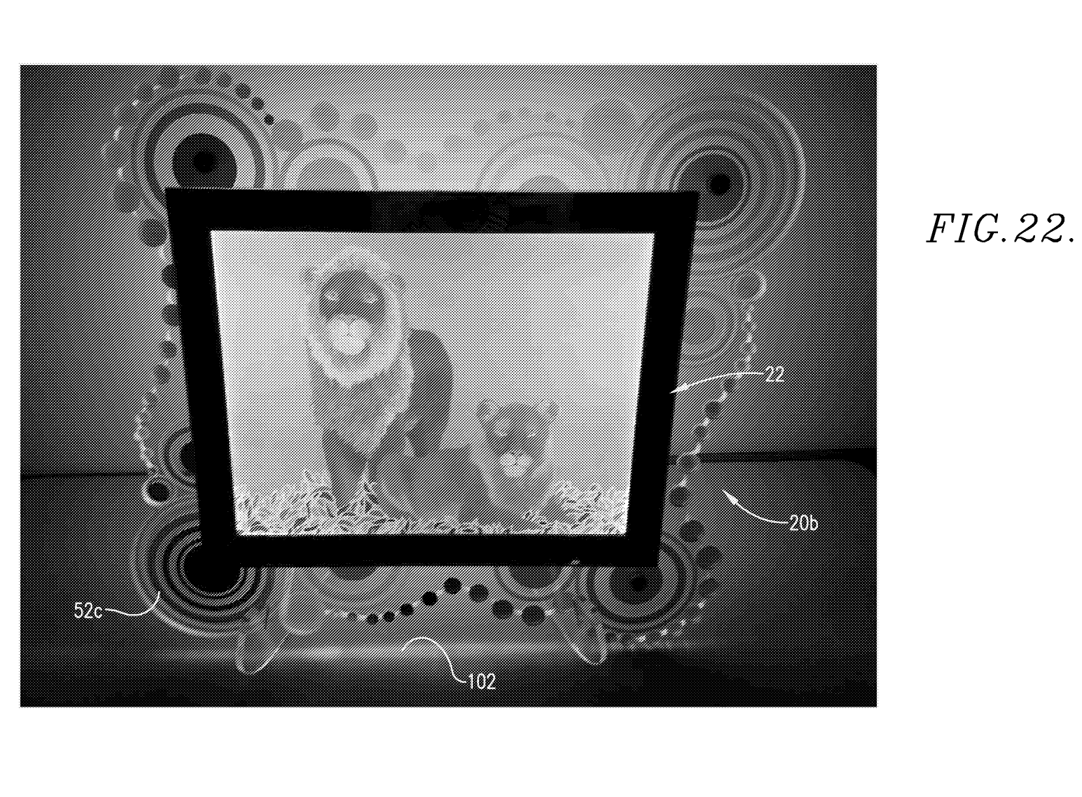

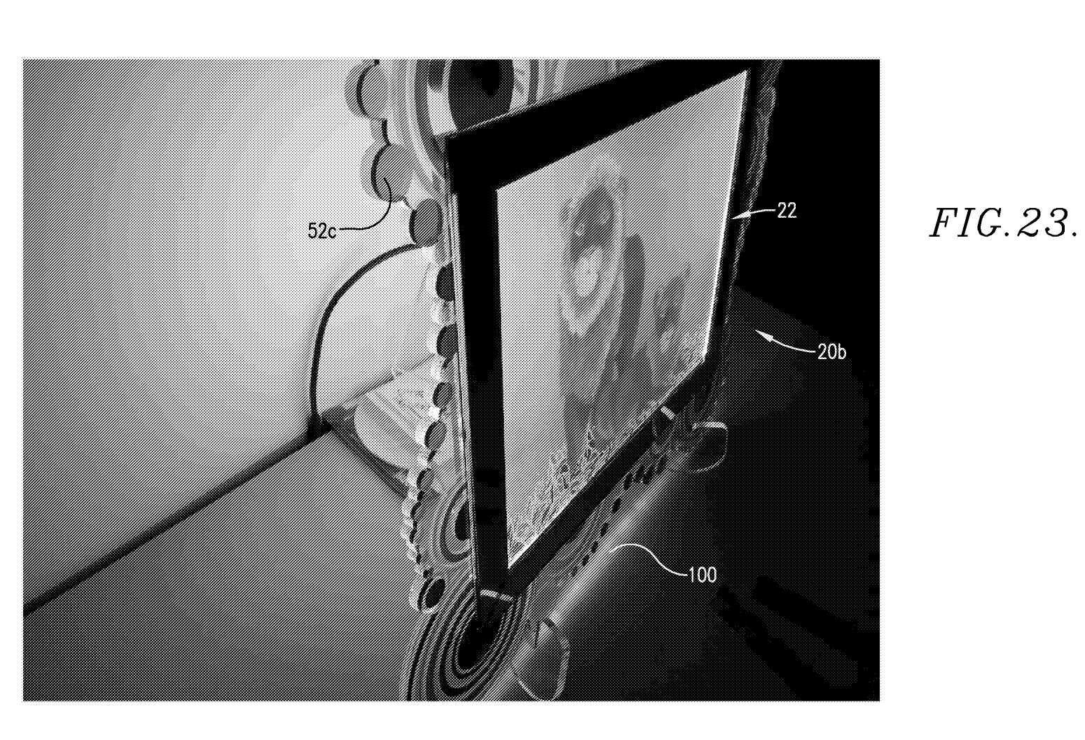

Embodiment of FIGS. 12-23

FIG. 12 is an elevational view of another display 20b having the same overall components as the display 20. However, display 20b is provided with a backing panel having a different surrounding margin 52c presenting a series of circular corner elements 94 and peripheral “bubbles” 96. In order to best illustrate the display 20b and the utility of the present invention, attention is drawn to the photographic FIGS. 13-23.

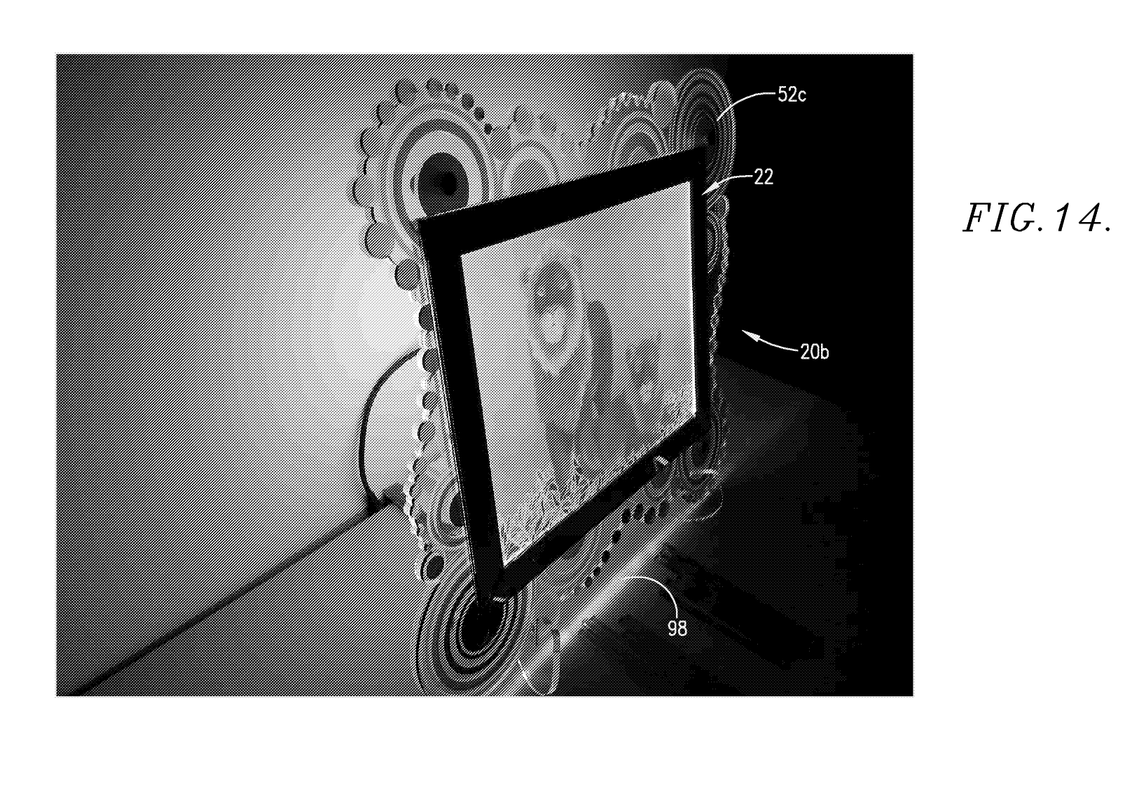

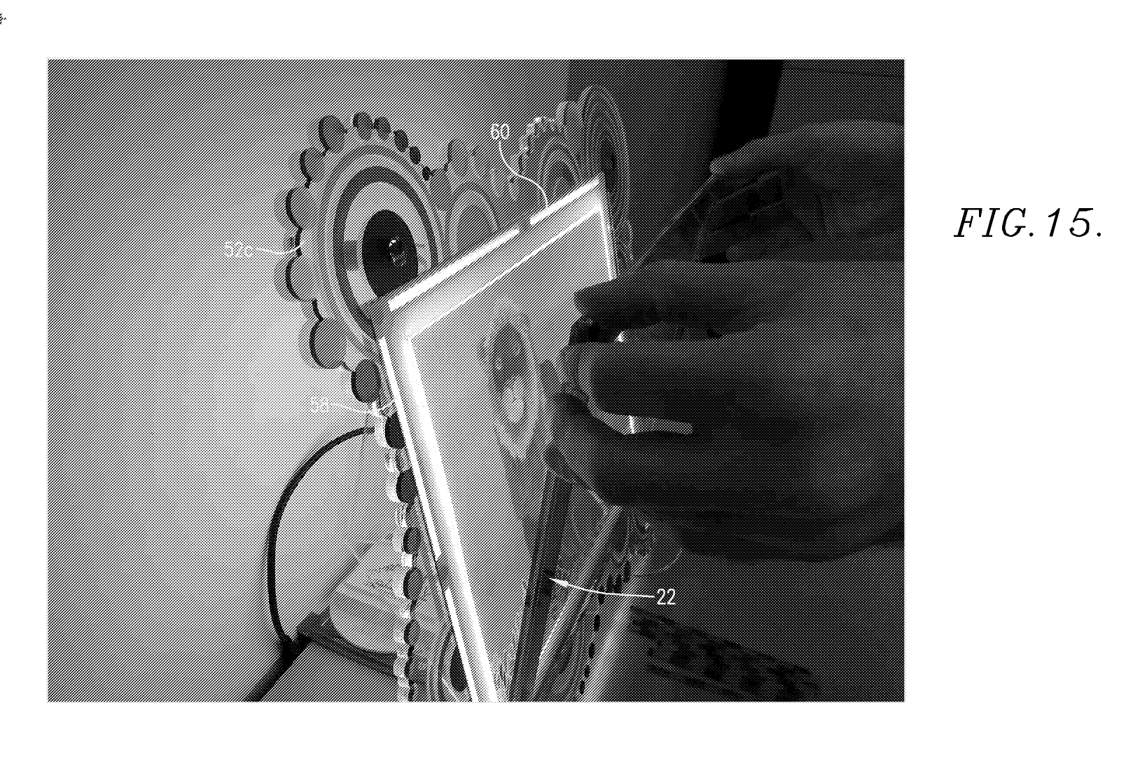

First, FIGS. 13 and 14 illustrate the display 20b without the use of any coloration elements 88 within the slots 58 and 60. Thus, it will be observed that the display casts an essentially white light strip 98 along the bottom of the display, and also along the side margin thereof (FIG. 14).

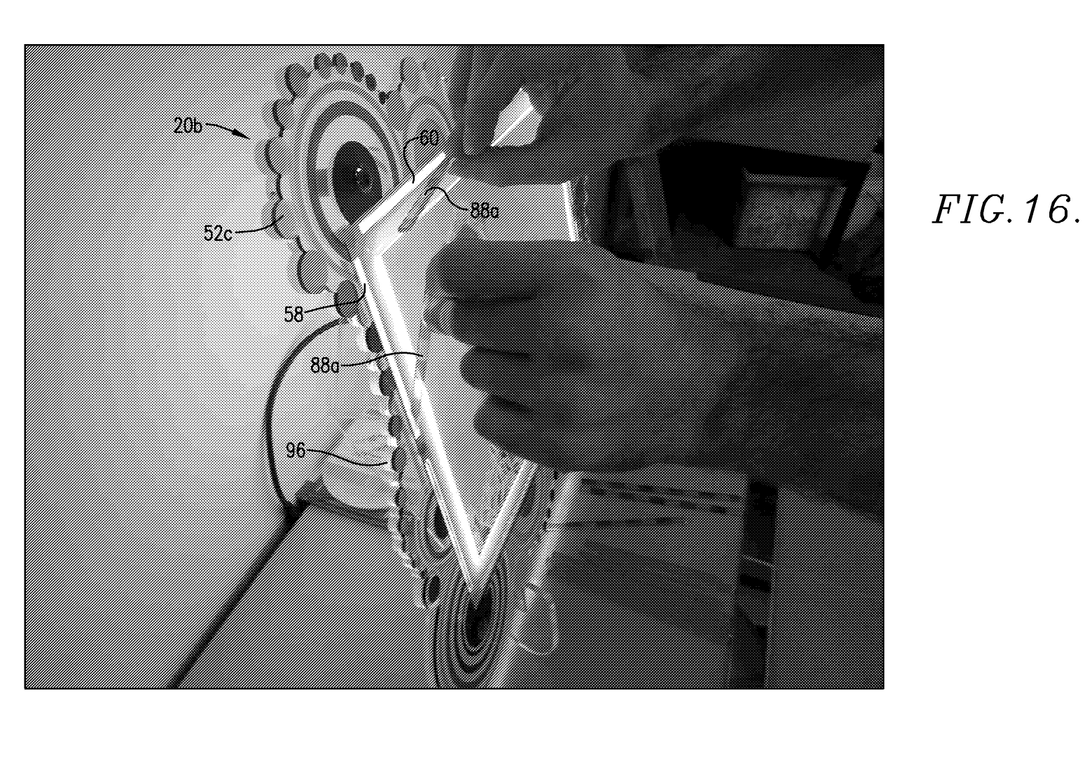

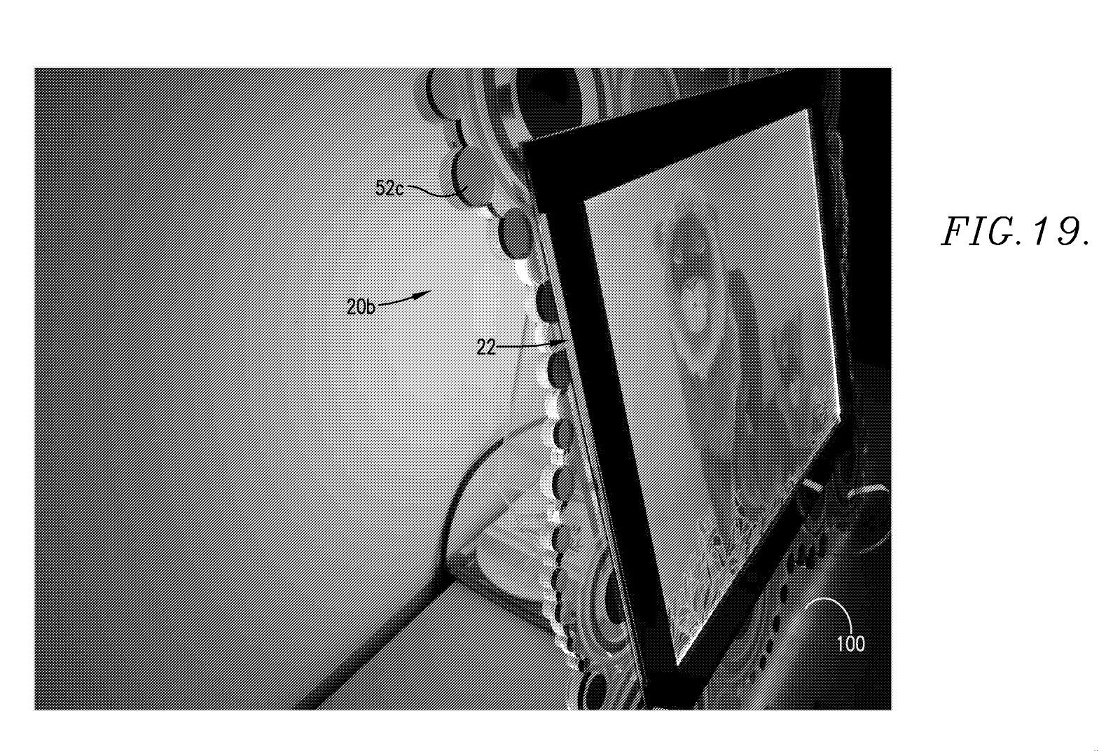

If it is desired to change the visual effect of the display 20b, it is only necessary to open the media cover 22 (FIG. 15) to expose the open slots 58 and 60 and to insert multi-colored coloration elements 88a into those slots (FIG. 16). In this illustration, multi-colored elements 88a are employed having different colors along the lengths thereof. As a consequence, the display 20b casts a multi-colored light strip 100 along the bottom of the display, and also along the side margin thereof (FIGS. 18 and 19).

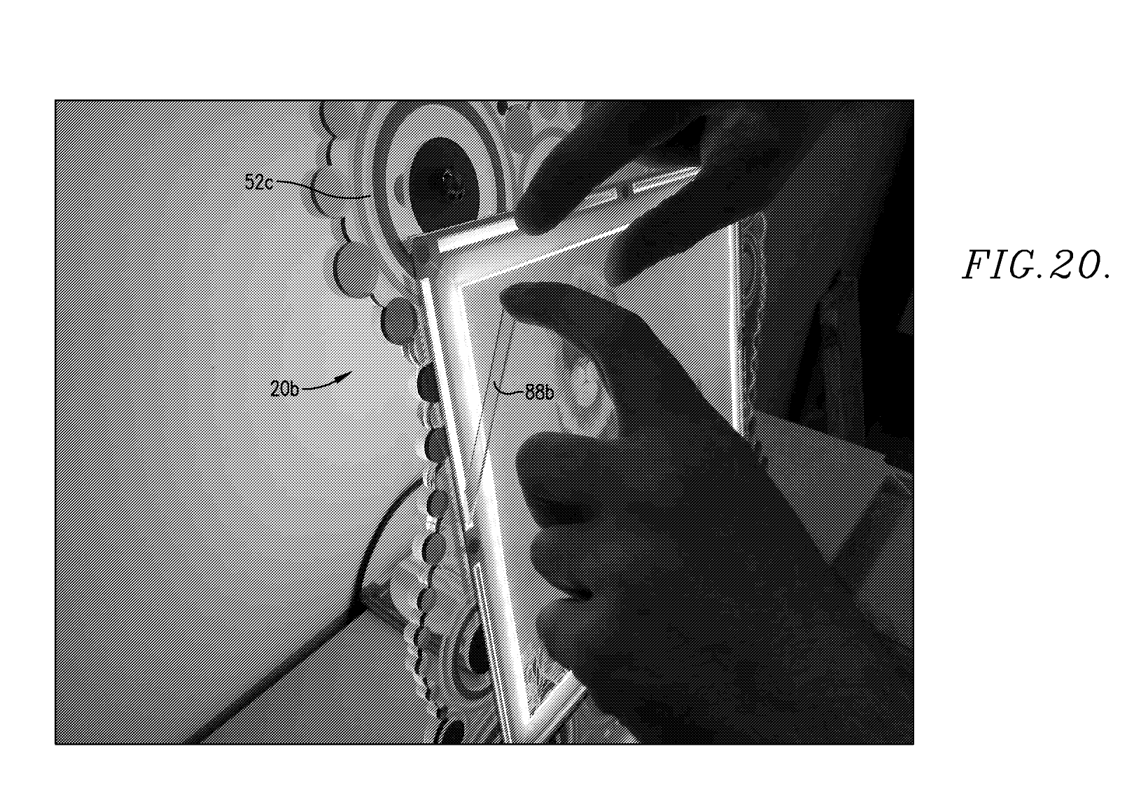

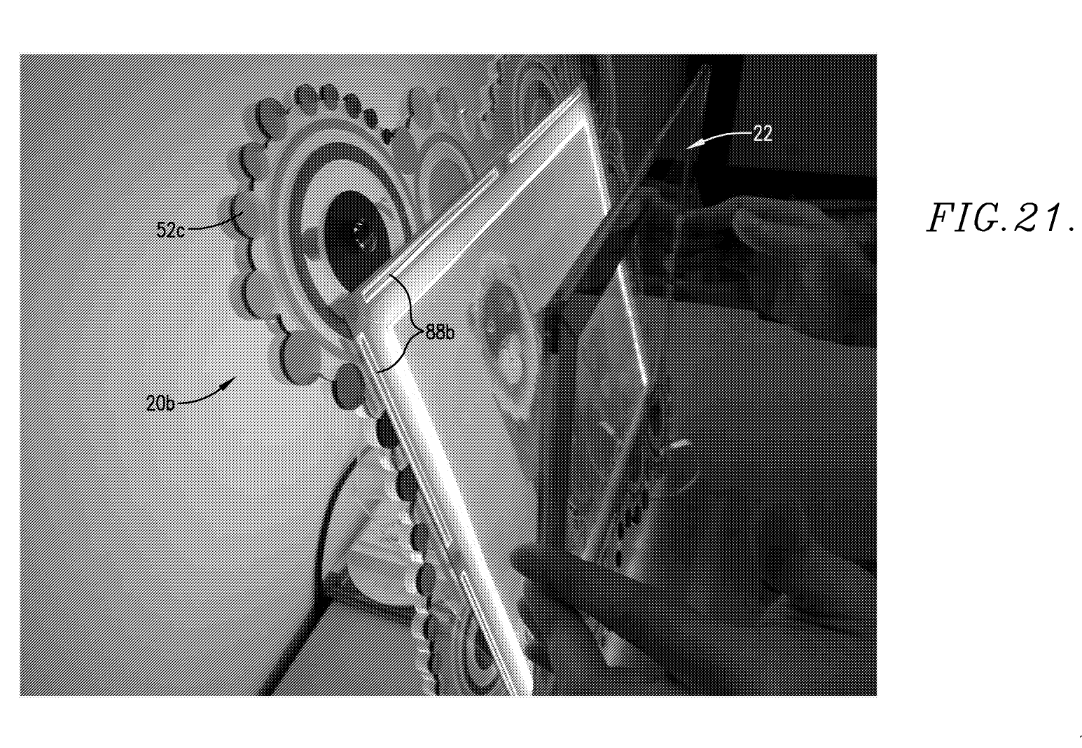

A similar modification can be effected by again opening the media cover 22, removing the light bars 88a, and substituting therefor amber-colored light bars 88b (FIG. 20), and then closing the cover 22, so that amber-colored light strips 102 are generated by the display (FIGS. 21-23).

It should be understood that the depicted embodiments are exemplary only, and many details of construction can be altered without departing from the spirit and scope of the present invention. For example, while magnetic quick-connect devices have been employed in these embodiments, any number of quick-connect devices may be used in lieu thereof, e.g., Velcro® components, quarter-turn connectors (such as those commercialized by Southco, Inc. under the designation “DZUS®”), snap components, hinge/latch components, or combinations thereof. The goal is to entrap the media sheet 24 between the central panel section 50 and the media cover 22, while permitting easy manual access for changeover of the sheet 24, without the need for unthreading nuts or the like, or extensive disassembly of the displays.

Very importantly, the types and locations of the light-scattering structures can be varied to give an almost infinite number of display effects. These structures can be prism-like, as described, but these structures are in no way limited to planar prisms. Various arcuate surfaces may be used in lieu of the prism-like elements and the locations thereof may be strategically selected in order to concentrate light at desired areas, especially around the outer margins of the displays. In like manner, any type of coloration element may be used, and this is not limited to the quadrate bars in the exemplary embodiments. These elements may be curvilinear or angular in shape, and may have various cross-sections, e.g., circular, square, rectangular, oval, and the like.

The materials used in fabricating the various components of the displays can be changed as desired by the designer or to meet the dictates of a particular desired display. Generally, synthetic resin components are used for ease of manufacture and low costs, but metallic components may also be used.

The displays of the invention may be mounted on a vertical wall surface, as through the use of the described standoff assemblies. Alternately, the displays may be mounted on an easel or at any other desired location.

We claim:

1. A display, comprising:
a backing panel presenting opposed front and rear faces and a thickness between said opposed faces,
said backing panel having a central panel section oriented to receive a replaceable sheet of light-transmitting media bearing an image, so that the media sheet is located proximal to the front face of said central panel section;
a light-transmitting cover located over said central panel section and media;
an illumination assembly operable illuminate said media and image in order to permit viewing of the image through the cover; and
structure supporting said cover in said covering relationship over said media, including a quick-release device permitting rapid manual shifting of the cover to expose said media and to permit replacement thereof with new media bearing another image.

2. The display of claim 1, said backing panel formed of substantially white and opaque synthetic resin material, one face of the backing panel being laser-etched.

3. The display of claim 1, said quick-release device selected from the group consisting of magnetic components, Velcro® components, quarter-turn connector components, snap components, hinge/latch components, and combinations thereof.

4. The display of claim 1, said illumination assembly comprising a plurality of LED lights located adjacent said backing panel and oriented to transmit light through the thickness of said backing panel in order to illuminate the central panel section and said media.

5. The display of claim 4, there being light-scattering structure between said LED lights and said central panel section in order to scatter the light emitted by said LED lights so as to substantially evenly illuminate said central panel section.

6. The display of claim 5, said light-scattering structure comprising a plurality of light-transmitting prism-like elements operable to scatter the light emitted by said LED lights.

7. The display of claim 6, said prism-like elements being of different shapes.

8. The display of claim 7, said backing panel having a margin extending outwardly from said central panel section and media, said illumination assembly operable to illuminate at least a portion of said margin.

9. The display of claim 8, including a replaceable coloration element located within the path of the margin-illuminating light from said illumination assembly, in order to permit illumination of said margin with one or more selected colors.

10. The display of claim 9, said coloration elements including a plurality of different colors along the lengths thereof.

11. The display of claim 1, including a mounting assembly for mounting of the display to a vertical wall surface.

12. The display of claim 1, said backing panel formed of substantially white and opaque synthetic resin material, with the rear face thereof being laser-etched, said cover comprising a sheet of substantially transparent synthetic resin material with a peripheral frame around the sheet, said cover-supporting structure comprising magnetic components operably coupled with said backing sheet and said cover in order to magnetically couple the cover to the backing sheet with said media therebetween, said magnetic components permitting said rapid manual shifting of the cover and replacement thereof.

13. A display, comprising:
a backing panel having opposed front and rear faces and a thickness between said opposed faces, said backing panel presenting a central panel section and a margin extending outwardly from the central panel section;
an illumination assembly including a plurality of LED lights oriented to direct light emitted by the LED lights through at least a portion of said backing panel; and
a replaceable coloration element located in the path of said emitted light in order to permit illumination of said back panel portion with one or more selected colors.

14. The display of claim 13, the rear face of said central panel section being laser-etched.

15. The display of claim 13, including light-scattering structure in the path of said light from said emitted light in order to scatter said light.

16. The display of claim 13, said LED lights disposed between said central panel section and said margin, said LED lights oriented to direct said emitted light through the thickness of the central panel section in order to illuminate the central panel section, said central panel section and said illumination assembly operable to cooperatively reflect a portion of said emitted light through the thickness of said margin in order to illuminate the margin, said coloration element located in the path of said reflected light in order to permit illumination of said margin with one or more selected colors.

17. The display of claim 15, including inboard light-scattering structure between said LED lights and said central panel section in order to scatter said emitted light so as to substantially evenly illuminate said central panel section of said backing panel.

18. The display of claim 13, said inboard light-scattering structure comprising a plurality of light-transmitting prism-like elements operable to scatter said emitted light.

19. The display of claim 16, including outboard light-scattering structure oriented to scatter said reflected light prior to passage thereof through said coloration element.

20. The display of claim 19, said outboard light-scattering structure comprising a plurality of light-transmitting prism-like elements operable to scatter said reflected light.

21. The display of claim 13, said illumination assembly operable to differentially direct said emitted light so that at least one portion of said backing panel is illuminated to a greater extent than another portion of said backing panel.

22. A method of illuminating a display including a backing panel having opposed front and rear faces and a thickness between the opposed faces, said method comprising the steps of directing light emitted by a plurality of LED lights first through a replaceable coloration element in order to change the color of said light, and thereafter directing said light through at least a portion of said backing panel.

23. The method of claim 22, including the step of scattering said emitted light prior to passage of the light through said coloration element.

24. The method of claim 22, said display panel presenting a central panel section and a margin extending outwardly from said central panel section, said method further comprising the steps of directing said emitted light through said central panel section in order to illuminate said central panel section, causing a portion of said emitted light to reflect and pass first through said coloration element and then through the thickness of said margin in order to illuminate the margin.

25. The method of claim 24, including the step of scattering said reflected light prior to passage thereof through the coloration element.

26. The method of claim 24, including the step of differentially directing said reflected light so that at least one portion of said margin is illuminated to a greater extent than another portion of said margin.
